(19) United States
(12) Patent Application Publication
(10) Pub. No.: US 2020/0066051 A1
(43) Pub. Date: Feb. 27, 2020

(54) MINDFUL ART FOR STRESS RELIEF USING AN AUGMENTED REALITY MOBILE APPLICATION THAT ALLOWS BOTH ELECTRONIC AND PRINTED COLORING THAT THEN TURNS INTO A 3D ANIMATED RENDERING OF THE COLORED ART

(71) Applicant: Stayhealthy, Inc., Monrovia, CA (US)

(72) Inventors: Anthony Lester Madden, Dallas, TX (US); Sagi Kormandel, Encino, CA (US); John R. Collins, Claremont, CA (US); Colin Kenneth Hill, San Dimas, CA (US)

(21) Appl. No.: 16/545,926

(22) Filed: Aug. 20, 2019

Related U.S. Application Data
(60) Provisional application No. 62/720,594, filed on Aug. 21, 2018.

(51) Int. Cl. G06T 19/00; G06T 11/00; G06T 19/20

(52) U.S. Cl. CPC G06T 19/006; G06T 11/001; G06T 2200/04; G06T 2219/2012; G06T 19/20

(57) ABSTRACT

A mindful art for a stress relief system using an augmented reality application that allows both electronic and printed coloring that turns into a 3D rendering of the colored art and includes a control system having a downloadable application connected to a website. The downloadable application has the option of printing the image to be colored or displaying the image for coloring with the application on a personal electronic device.

### CROSS REFERENCE TO RELATED APPLICATION

This application claims the benefit of the priority of U.S. Provisional Application No. 62/720,594 filed on Aug. 21, 2018, the contents of these applications are hereby incorporated by reference in their entirety.

### BACKGROUND OF THE INVENTION

This invention is directed to a system for providing stress relief using an augmented reality mobile application that allows both electronic and printed coloring that turns two-dimensional (2D) images into three-dimensional (3D) animated renderings of the colored 2D images.

Based on clinical evidence it is known that both adult and children coloring can be a restful and focused activity that allows the mind to rest and can thus act as a stress reducer. While many, and particularly children, enjoy coloring, educating and motivating people about their health and improving upon health issues remains challenging.

The development of mobile applications and augmented reality have made the distribution of information easier and more entertaining. While useful, these applications have failed to present health information in an appealing manner, particularly for children, while also providing a health benefit, namely, reducing stress. Therefore, there exists a need in the art for a system that will address these deficiencies.

An objective of the present invention is to provide a stress relief and health system that presents health information in an entertaining manner, especially for children.

Another objective of the present invention is to provide a stress relief and health system that provides a health benefit.

These and other objectives will be apparent to those of ordinary skill in the art based upon the following written description, drawings and claims.

### SUMMARY OF THE INVENTION

A stress relief and health system includes a control system with downloadable applications and memory, or alternatively, a cloud based storage. The control system is connected to a website or app store having a user interface. A user, having a personal electronic device, is able to access the website or app store and download the application to the user's personal electronic device.

The downloadable application includes images that can be printed or displayed on the electronic device for coloring. The colored image is converted to image data, and by activating an AR icon. The 2D image data is converted to a 3D object. Preferably, at the same time, or later, a health fact is displayed on the user's device. The user can create pictures and videos with the 3D object, and share the pictures or video on social media. The application also prompts the user to select additional images for coloring.

### BRIEF DESCRIPTION OF THE DRAWINGS

FIG. 1 is a schematic view of a stress relief and health system; and

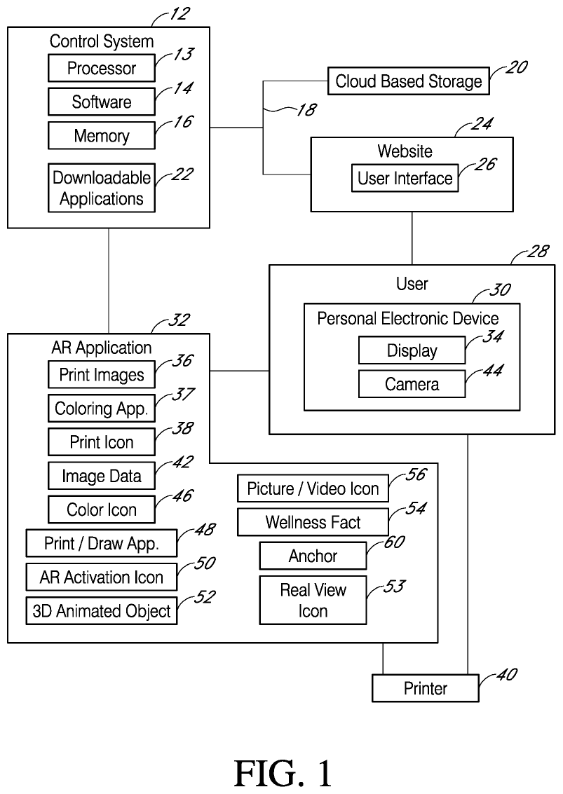

FIG. 2 is a flow diagram for a stress relief and health system.

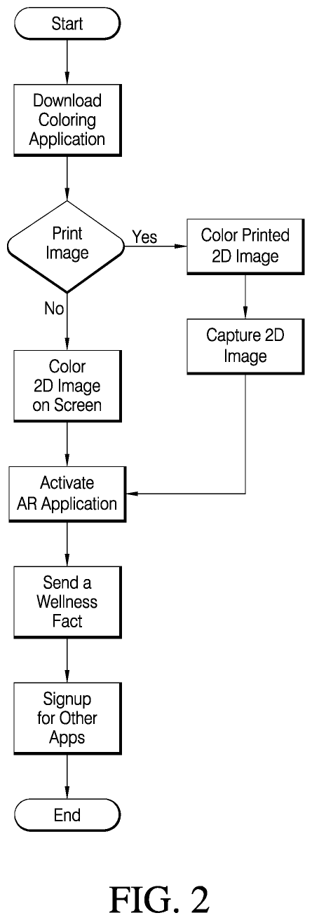

### DETAILED DESCRIPTION OF THE PREFERRED EMBODIMENTS

A stress relief and health education system 10 includes a control system 12 having a processor 13, software 14, and memory 16. Alternatively, the control system 12 is connected, via an electronic network 18, to a cloud based storage 20. Stored within the memory 16, or the cloud based storage 20, are a plurality of downloadable applications 22 preferably related to health.

The control system 12 is connected via the electronic network 18 to a website 24. The website 24 has a user interface 26 that permits a user 28 to access, select, and download to a personal electronic device 30 one or more of the downloadable applications 22. The personal electronic device 30 includes, but is not limited to, a mobile phone, a tablet, a personal computer, or the like.

One of the downloadable applications 22 includes electronic and printed images for coloring with augmented reality (AR) rendering 32. The coloring application 32, once downloaded, prompts a user 28 on a display 34 of the electronic device 30 by asking if they wish to print an image 36 or if they wish to color in the coloring application 32. If the user 28 selects a printing icon or button 38 on the display or through a voice command, the image 36 is printed in 2D using a printer 40 connected to the electronic device 30. Once printed, the user 28 colors the image 36 using crayons, colored pencils, paints, or the like. While the image 36 can be of anything, preferred, are characters or cartoon versions of all the major organs—the brain, lungs, kidneys, stomach, small intestine, colon, and the like.

Once the image 36 is colored, the user 28 captures image data 42 of the image 34 using a camera 44, or the like, associated with the electronic device. Alternatively, if the user 28 elects to color in the coloring application 32 the user selects a color button or icon 46, or selects through voice command, and the image 36 appears on display 34. Using electronic painting or drawing applications 48 within the coloring application 32 that includes an endless amount of colors to choose from by way of a digital in app color wheel/color picker, a thickness bar to adjust the shape and size of the virtual brush and the like, the user colors the image 36 on the display 34 as user colors the 2D image 36. For example, a line drawing of a heart appears on the display 34. The user 28 taps on a selection of colors and brush shapes and sizes using their fingers. They can drag their finger across the area to be colored or tap on the area to be colored. The user 28 can also use a virtual eraser to erase mistakes or tap on a clear button to erase all color and start over. The user can also zoom in using simple hand commands such as a pinch and zoom or press on a zoom button in order to pan around the enlarged image to color in the harder to reach or see areas while in its 1:1 original size. As the image 36 is colored, the coloring application collects and stores image data 42.

Once the image data 42 has been captured or competed, the user selects an AR activation button or icon 50, or selects via voice command. Upon selection of icon 50, the user will be asked to wave their mobile device over the surface they would like to see the character appear onto in order for the application to detect the surface and lock it in place while the user is tracking the character, the coloring application 32 processes the image data 42 to convert the 2D image 36 into a 3D animated object 52. Preferably, in processing the image data 42 the coloring application 32 displays an animated swirl or any particle/transition animation/visual effect that turns into a 3D animated object 52. This is done without the need for a printed marker. The 3D animated object maintains the coloring characteristics applied by the user 28. As the image data 42 is converted, the coloring application selects a wellness fact 54 that is displayed with the 3D animated object. In addition, the application will display a health-related fact or tip every time the user launches the device's camera when selecting an augmented reality action. These tips and facts will be pulled from a database in a randomized fashion but relate to the image being colored in order to keep the app fresh every time the user replays the game/app 52. In addition, the coloring application 32 can provide music to which the 3D animated object 52 responds or dances.

Once the 3D animated object 52 is created, the user 28 can select a button or icon 56 or through voice command to take a picture or video with the 3D animated object 52. More specifically, the user 28 points the electronic device 30 toward an area in the real-world environment to be captured which can include other individuals and then touches the spot on the display 30 where the user 28 wants the 3D animated object 52 to align. Once selected, the coloring application 32 moves the 3D animated object 52 to the selected spot or anchor 60. Once anchored, the user can move toward and away from the 3D animated object 52 and the 3D object 52 will adjust or scale in size. Also, the user can move around, rotate, walk around the 3D animated object 52 which stays in place to capture different sides or angles of the 3D animated object 52. Once positioned, the user 28 activates the camera 44 to record a photo or video that includes the 3D animated object 52. Using the coloring application 32, the photo or video can be shared with others via the electronic network 18. Each video will have the ability to add a logo, watermark or any text or graphics to be composited onto the final video that is shared. For example, the user may only see a 3D model of an animated heart dancing on their table while shooting a video, but the end result of the video they share may have the dancing heart on their table along with a logo in the corner and a health tip on the bottom that was not visible during the making the video.

The user 28 can also tap on a “real view” button or icon 53 at any time after they have activated the AR activation button 50. Upon activation of button 53, the display would be replaced by a series of videos or png sequences that are shown in AR at the same spot, or not, as where the 3D animated object 52 was positioned in the previous display. An example of this is disclosed in U.S. Pat. Nos. 9,600,939, 9,972,114 and pending U.S. Ser. No. 15/962,695 incorporated herein by reference in their entirety.

After a predetermined amount of time, the coloring application 32 prompts the user 28 by asking if the user 28 wishes to sign-up to receive more images 36 to color, or to receive additional health tips or information. In addition the user may be asked to pay a fee to disable image and video ads that will be served up through the app in certain locations. To sign-up the user 28 provides personal information and the process is repeated. A different image 36 and wellness fact will be provided each time through the process. The coloring application 32 will also prompt the user 28 by asking if they wish to share the coloring application 32 with others whereby the application is shared via the electronic network. The coloring application 32 can also direct the user to other applications 22 for download.

From the above discussion and accompanying figures and claims it will be appreciated that a stress relief and health education system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A stress relief and health coloring system, comprising:
a control system having a downloadable application;
a website having a user interface connected to the control system;
a personal electronic device adapted to download the downloadable application from the website to the personal electronic device;
wherein the personal electronic device is adapted to capture image data of an image colored by a user and convert the image data into a 3D object using an AR activation icon.

2. The system of claim 1 wherein the image colored by a user is selected from the downloadable application and printed from and scanned to the personal electronic device.

3. The system of claim 1 wherein the image colored by the user is selected from the downloadable application and displayed on the personal electronic device, and is colored using a coloring application on the downloadable application.

4. The system of claim 1 wherein a wellness fact is displayed with the 3D object.

5. The system of claim 1 wherein the image colored by a user is a character of a human organ, or a character of a healthy fruit or vegetable or characters of other foods that are not considered healthy.

6. The system of claim 1 wherein a picture or video is captured by the user of the 3D object.

7. The system of claim 6 wherein the picture or video is shared through social media.

8. The system of claim 1 wherein the downloadable application after a predetermined amount of time is asking if the user wishes to sign-up for more images to color.
